(19) United States
(12) Patent Application Publication
(10) Pub. No.: US 2026/0368453 A1
(43) Pub. Date: Nov. 19, 2026

(54) GENERATING SYNTHETIC DATA USING GENERATIVE ARTIFICIAL INTELLIGENCE AND TAXONOMY TRIPLETS

(71) Applicants: AT&T Intellectual Property I, L.P., Atlanta, GA (US); AT&T Communications Services India Private Limited, Bangalore (IN); AT&T Global Business Services India Pvt. Ltd., New Delhi (IN)

(72) Inventors: Prashanth Ramappa, Bengaluru (IN); Druva M. Hegde, Mangalore (IN); Gagan Yadav S., Bengaluru (IN); Abhay Dabholkar, Allen, TX (US); Mark Austin, Allen, TX (US); Amit Shukla, Bangalore (IN)

(21) Appl. No.: 19/211,130

(22) Filed: May 16, 2025

(51) Int. Cl. G06F 40/58

(52) U.S. Cl. CPC G06F 40/58

(57) ABSTRACT

An example method includes acquiring a text phrase that is part of a training dataset used to train a large language model, extracting, from the text phrase, a subject-verb-object relationship, rephrasing the subject-verb-object relationship to produce a synthetic text phrase, adding the synthetic text phrase to the training dataset to produce an augmented training dataset, and retraining the large language model using the augmented training dataset.

### RELATED APPLCATION

The present disclosure relates generally to machine learning techniques and relates more particularly to devices, non-transitory computer-readable media, and methods for generating synthetic data using generative artificial intelligence and taxonomy triplets.

### BACKGROUND

A large language model (LLM) is a type of machine learning model designed for natural language processing (NLP) tasks, including tasks that understand, generate, and use human language. LLMs are trained on massive amounts of data and use deep learning to learn how words, characters, and sentences relate to each other. Some of the most widely used types of LLMs include generative pre-trained transformers (GPTs) such as GPT-4 and bidirectional encoder representations from transformers (BERTs).

### SUMMARY

Devices, non-transitory computer-readable media, and methods for generating synthetic data using generative artificial intelligence and taxonomy triplets are disclosed. An example method includes acquiring a text phrase that is part of a training dataset used to train a large language model, extracting, from the text phrase, a subject-verb-object relationship, rephrasing the subject-verb-object relationship to produce a synthetic text phrase, adding the synthetic text phrase to the training dataset to produce an augmented training dataset, and retraining the large language model using the augmented training dataset.

In another example, a non-transitory computer-readable medium stores instructions which, when executed by a processing system including at least one processor, cause the processing system to perform operations. The operations include acquiring a text phrase that is part of a training dataset used to train a large language model, extracting, from the text phrase, a subject-verb-object relationship, rephrasing the subject-verb-object relationship to produce a synthetic text phrase, adding the synthetic text phrase to the training dataset to produce an augmented training dataset, and retraining the large language model using the augmented training dataset.

In another example, a device includes a processing system including at least one processor and a non-transitory computer-readable medium. The non-transitory computer-readable medium stores instructions which, when executed by the processing system, cause the processing system to perform operations. The operations include acquiring a text phrase that is part of a training dataset used to train a large language model, extracting, from the text phrase, a subject-verb-object relationship, rephrasing the subject-verb-object relationship to produce a synthetic text phrase, adding the synthetic text phrase to the training dataset to produce an augmented training dataset, and retraining the large language model using the augmented training dataset.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for generating synthetic data using generative artificial intelligence and taxonomy triplets may operate;

FIG. 2 illustrates a flowchart of an example method for generating synthetic data using generative artificial intelligence and taxonomy triplets, in accordance with the present disclosure;

FIG. 3 illustrates how a subject-verb-object taxonomy triplet may be extracted from an example input text phrase; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for generating synthetic data using generative artificial intelligence and taxonomy triplets. As discussed above, an LLM is a type of machine learning model designed for NLP tasks, including tasks that understand, generate, and use human language. LLMs are trained on massive amounts of data and use deep learning to learn how words, characters, and sentences relate to each other. Some of the most widely used types of LLMs include generative pre-trained transformers (GPTs) such as GPT-4 and bidirectional encoder representations from transformers (BERTs).

It can often be difficult to obtain the data required to adequately train an LLM, due not only to the amount of training data needed, but also to privacy regulations such as General Data Protection Regulation (GDPR) and to the labor-intensive processes needed to create clean datasets using traditional methods. If adequate training data is not provided to train an LLM, then the quality of the data generated by the LLM may be uncertain. The inherent variability in human language proficiency may further contribute to ambiguity and lower quality datasets.

In the rapidly evolving domain of NLP, the efficacy of fine-tuning LLMs largely depends on the availability of extensive and high-quality training data. LLMs require diverse datasets to effectively learn the myriad ways in which humans communicate. Unfortunately, existing datasets often do not encompass the full spectrum of linguistic expressions and nuances found in natural language. This lack of diversity can result in LLMs being biased toward the patterns presented in the training data, which may result in underperformance in real-world scenarios in which input can vary significantly. Additionally, many existing datasets lack the depth required to fully capture the context of interactions. This can be especially problematic in domains in which context is crucial (e.g., customer service, healthcare, finance, and the like). There is also a trade-off between the quality and the quantity of data in existing datasets. Larger datasets often contain more noise and irrelevant information, whereas higher-quality data sets (which contain less noise and irrelevant information) are often too small to be of effective use in training robust LLMs.

Examples of the present disclosure generate synthetic data that may be of particular use in LLM fine-tuning, among other applications. In one example, generative artificial intelligence (GenAI) techniques are leveraged to dynamically create taxonomy triplets based on sample inputs and custom triplets. The synthetic data is generated by passing the sample through a GenAI model. The disclosed approach, based on a custom taxonomy, enhances the fine-tuning of an LLM by providing domain-specific, high-quality synthetic data which improves the LLM’s overall performance and applicability in specialized fields. Examples of the present disclosure therefore increase the quality of synthetically created data while reducing the effort involved in creating the data.

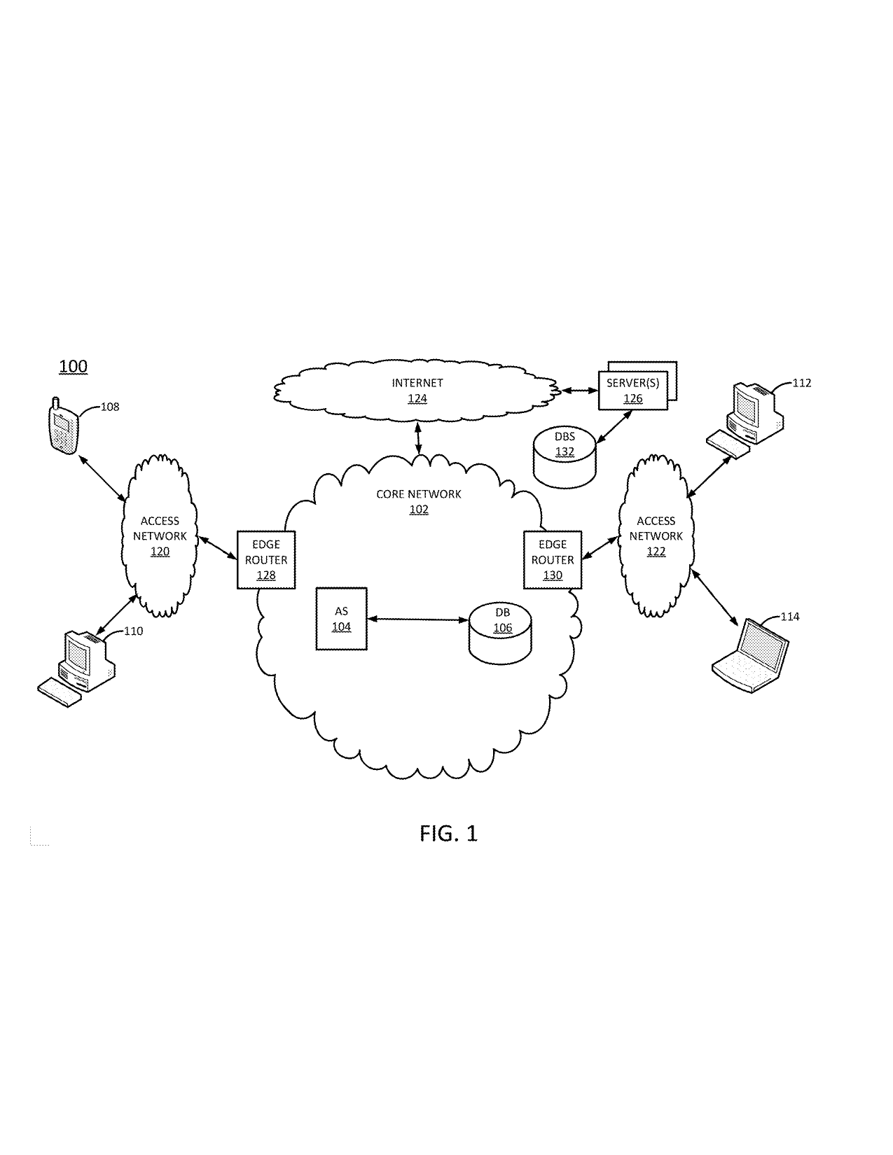

Within the context of the present disclosure, the terms “synthetic data” and “synthetically created data” are understood to refer to data that is obtained using GenAI techniques, as opposed to data that is obtained through observation in the real world. In other words, synthetic data is artificial data that does not exist in the real world, although synthetic data may mimic the patterns observed in data that exists in the real world. The techniques of the present disclosure that are used to generate synthetic data may be applicable across a variety of domains due to the dynamically created taxonomies and GenAI usage. Moreover, although examples of the present disclosure are discussed within the context of training LLMs, it will be appreciated that the synthetic data generated according to the disclosed techniques could be used to train other types of machine learning models, including small language models and embedding models, among others. These and other aspects of the present disclosure are discussed in greater detail below in connection with the examples of FIGS. 1-4.

To further aid in understanding the present disclosure, FIG. 1 illustrates an example system 100 in which examples of the present disclosure for generating synthetic data using generative artificial intelligence and taxonomy triplets may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. For example, the operator of the core network 102 may provide a cable television service, an IPTV service, media streaming service, or any other types of communication services to subscribers via access network 120 or access network 122. In one example, the core network 102 may be operated by a telecommunication network service provider. The core network 102 and the access networks 120 and 122 may be operated by different service providers, the same service provider or a combination thereof, or the access networks 120 and 122 may be operated by an entity having a core business that is not related to telecommunications services, e.g., corporate, governmental, or educational institution LANs, and the like.

In one example, the access network 120 may be in communication with user endpoints (UEs) 108 and 110. The access network 120 may transmit and receive communications between the UEs 108 and 110, between the UEs 108 and 110 and the server(s) 126, the AS 104, other components of the core network 102, devices reachable via the Internet in general, and so forth. Similarly, the access network 122 may be in communication with UEs 112 and 114. The access network 122 may transmit and receive communications between the UEs 112 and 114, between the UEs 112 and 114 and the server(s) 126, the AS 104, other components of the core network 102, devices reachable via the Internet in general, and so forth.

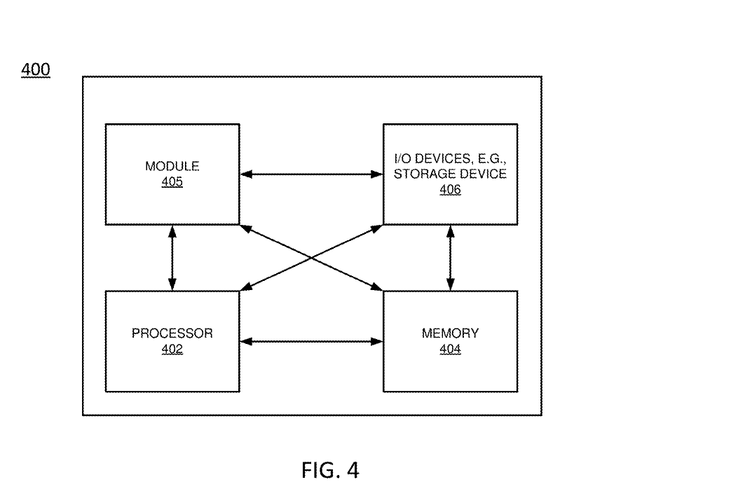

In one example, each of the UEs 108, 110, 112, and 114 may comprise any type of user endpoint device that is capable of communicating with and controlling operations of the AS 104 and/or server(s) 126. For instance, each UE 108, 110, 112, or 114 may comprise a desktop computer, a laptop computer, a tablet computer, a smart phone, a gaming console, an Internet of Things (IoT) device, a wearable smart device (e.g., a smart watch, smart glasses, or the like), or the like. For instance, each UE 108, 110, 112, or 114 may display a user interface via which a user may interact with the AS 104 or the server(s) 126 to generate synthetic data, as described in further detail below. Alternatively, any of the UEs 108, 110, 112, or 114 may run an application locally that may generate synthetic data without the assistance of the AS 104 or the server(s) 126. To this end, any one or more of the UEs 108, 110, 112, or 114 may comprise one or more physical devices, e.g., one or more computing systems or servers, such as computing system 400 depicted in FIG. 4, and may be configured as described below.

In one example, one or more remote servers 126 may be accessible to the UEs 108, 110, 112, or 114 via the Internet 124 in general. In one example, the server(s) 126 may operate in a manner similar to the UEs 108, 110, 112, or 114 or may provide additional resources and/or data to support the generation of synthetic data. In another example, the server(s) 126 may operate in a manner similar to the AS 104, which is described in further detail below. In one example, DBs 132 may be accessible by the server(s) 126 and/or by the AS 104.

In accordance with the present disclosure, the AS 104 and DB 106 may be configured to provide one or more operations or functions in connection with examples of the present disclosure for generating synthetic data using generative artificial intelligence and taxonomy triplets, as described herein. For instance, the AS 104 may execute a machine learning model, such as an LLM. The AS 104 may also generate synthetic data that may be used to augment a training dataset that is used to train the machine learning model.

For instance, the AS 104 may retrieve training data from a training dataset stored in the DB 106. The training dataset may comprise a plurality of text phrases extracted from files, tables, and other documents. In other words, the training dataset may comprise observed data points, which in this case may be text phrases extracted from real-world documents. However, the training dataset may, at least initially, comprise a relatively limited number of such text phrases, which may be insufficient for training the machine learning model to effectively understand, process, and generate human-like language outputs.

Thus, the AS 104 may generate synthetic data to augment the training dataset. The AS 104 may utilize the original training dataset (e.g., the observed data points) as a starting point for generating the synthetic data. For instance, in one example, the AS 104 may extract, from text phrases in the original training dataset, subject-verb-object relationships (also referred to as taxonomy triplets) that capture the essential context or meaning of the text phrases. These subject-verb-object relationships may then be provided as inputs to a GenAI model executed by the AS 104, which may produce as an output one or more synthetic text phrases that utilize the same subject-verb-object relationships, but may express the relationships in different wording that the text phrases of the original training dataset. These synthetic text phrases may then be added to the training dataset to augment the training dataset, and the machine learning model (e.g., LLM) may be retrained or fine-tuned using the augmented training dataset.

To this end, the AS 104 may comprise one or more physical devices, e.g., one or more computing systems or servers, such as computing system 400 depicted in FIG. 4, and may be configured as described below. As discussed above, the AS 104 may have access to at least one database (DB) 106, where the DB 106 may store training datasets for various machine learning models.

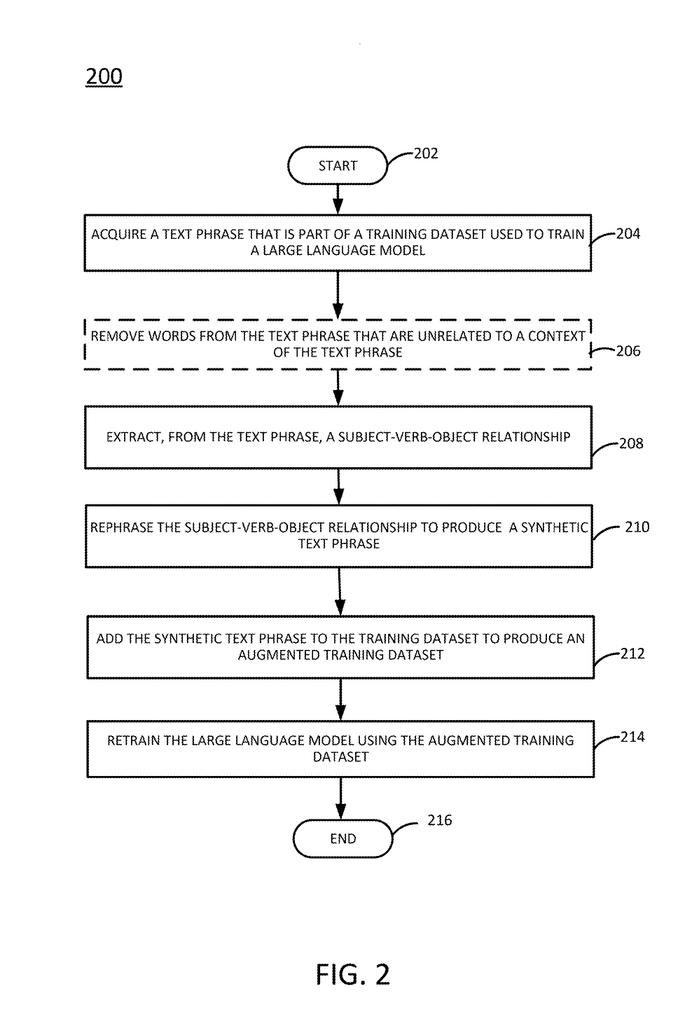

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for generating synthetic data using generative artificial intelligence and taxonomy triplets, as described herein. One example method for generating synthetic data using generative artificial intelligence and taxonomy triplets is described in greater detail below in connection with FIG. 2.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, media streaming server, a content distribution network (CDN) and the like. For example, portions of the core network 102, access networks 120 and 122, and/or Internet 124 may comprise a content distribution network (CDN) having ingest servers, edge servers, and the like. Similarly, although only two access networks 120 and 122 are shown, in other examples, the access networks 120 and 122 may comprise a plurality of different access networks that may interface with the core network 102 independently or in a chained manner. For example, UEs 108-114 may communicate with the core network 102 via different access networks. Thus, these and other modifications are all contemplated within the scope of the present disclosure.

FIG. 2 illustrates a flowchart of an example method 200 for generating synthetic data using generative artificial intelligence and taxonomy triplets, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 200 is described in greater detail below in connection with an example performed by a processing system, such as processor or processing system 402.

The method 200 begins in step 202 and proceeds to step 204. In step 204, the processing system may acquire a text phrase that is part of a training dataset used to train a large language model.

In one example, the training dataset may comprise a plurality of text phrases. The plurality of text phrases may be contained in a plurality of sentences, paragraphs, columns, or the like contained in files, tables, and other documents. For instance, the plurality of text phrases may include .doc files, CSV files, .xls files, .pdf files, .ppt files, and other types of files that contain textual data. The documents may include, for example, news articles, emails, transcripts of customer service calls or other audio or video calls, books, text messages, presentations, spreadsheets, charts, graphs, advertisements, or a summary of any of the above-mentioned documents. The LLM may comprise a GPT, a BERT, a chatbot, or the like. The method 200 may be implemented to fine-tune the LLM.

In optional step 206 (illustrated in phantom), the processing system may remove words from the text phrase that are unrelated to a context of the text phrase. In one example, the words that are removed are words that may inflate a prompt token, such as articles (e.g., “a,” “an,” “the,” etc.). The words may include any words that are unrelated to the context or meaning of the text phrase. This reduces noise and irrelevant information in the text phrase.

In step 208, the processing system may extract, from the text phrase, a subject-verb-object relationship. The subject-verb-object comprises a taxonomy triplet that expresses the essential elements of the text phrase. In one example, the subject-verb-object relationship additionally includes any words in the text phrase that occur after the object. Thus, the subject-verb-object relationship may capture the essential elements of the text phrase.

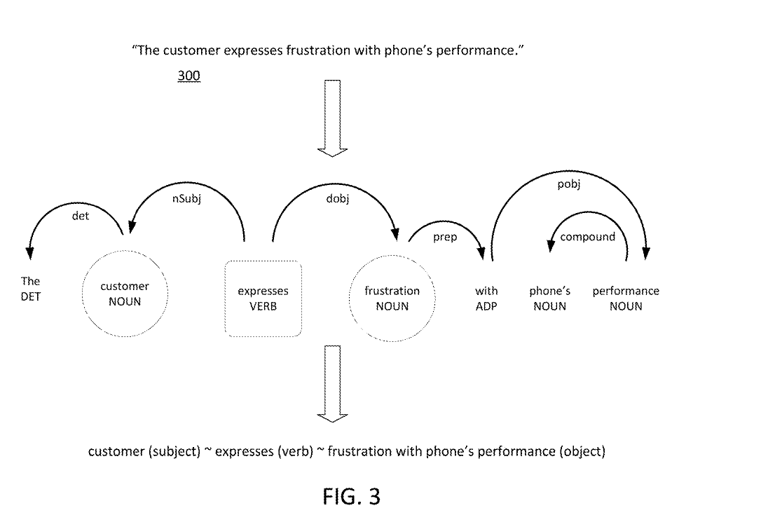

FIG. 3, for example, illustrates how a subject-verb-object taxonomy triplet may be extracted from an example input text phrase 300. As illustrated, the example input text phrase “The customer expresses frustration with phone’s performance” may be broken down into a plurality of individual words (i.e., “The,” “customer,” “expresses,” “frustration,” “with,” “phone’s,” and “performance”).

From these individual words, a plurality of key words may be parsed. These key words may include the subject, verb, and object of the subject-verb-object relationship. In the example of the input text phrase 300 of FIG. 3, the key words may include “customer” (noun), “expresses” (verb), and “frustration with phone’s performance” (object). It is noted that the object in this case includes the words occurring after the primary object of “frustration” in the input text phrase, including the preposition “with” and the object of that preposition (i.e., “phone’s performance”). Thus, the step 208 defines, within an input text phrase, the parts of speech of that input text phrase and how the parts of speech connect to each other.

In one example, natural language processing techniques may be used to extract the subject-verb-object relationship. For instance, the subject-verb-object relationship may be extracted using a dynamic context optimization technique (DCO) method or other syntactic parsing techniques. LLMs often remember the beginning and the end of a large context, but forget the middle, which can lead to errors when generating data from large inputs. DCO techniques help to identify the parts of a context that deserve greater focus or attention, such as the subject, action, and object, and to place these parts at the start of the context. This gives an LLM a clearer overview of the context and helps the LLM to better understand the context in its entirety. In a further example, the processing system may additionally perform sentiment analysis on the input text phrase to ensure that the subject-verb-object relationship expresses the same sentiment as the input text phrase.

The word “The” in the input text phrase 300 may be ignored or discarded as an extraneous word that does not contribute to the context or meaning of the input text phrase (e.g., as discussed in connection with step 206 of the method 200).

In step 210, the processing system may rephrase the subject-verb-object relationship to produce a synthetic text phrase.

In one example, the taxonomy triplet representing the subject-verb-object relationship may be provided as an input to a machine learning model, such as an LLM (e.g., a GPT-4) that generates the synthetic text phrase as an output. For instance, the taxonomy triplet may be provided as a prompt to the LLM along with a request to generate a synthetic text phrase that expresses the context of the taxonomy triplet. The machine learning model may expand the subject-verb-object relationship in addition to rephrasing the relationship. Rephrasing of the subject-verb-object relationship produces a new, synthetic text phrase that is different from the text phrase acquired in step 204 but that preserves the original context and meaning of the text phrase acquired in step 204.

In one example, the synthetic text phrase may be validated (e.g., using a critic model) to confirm that the synthetic text phrase is correct (e.g., the information contained in the synthetic text phrase is free of errors and maintains the integrity of the original text phrase), concise (e.g., expresses the information with a desired degree of clarity and brevity without using unnecessary words, so that the synthetic text phrase is easy to understand and efficient to read), and coherent (e.g., ideas in the synthetic text phrase are connected in a logical and orderly manner and contribute clearly and consistently to the overall meaning of the synthetic text phrase). In one example, if the synthetic text phrase fails to be validated as at least one of: correct, concise, or coherent, then the synthetic text phrase may be discarded (e.g., not utilized in further steps of the method 200).

In step 212, the processing system may add the synthetic text phrase to the training dataset to produce an augmented training dataset. In one example, the synthetic text phrase may be included as a new data point (e.g., a new text phrase) in the training dataset. Thus, the augmented training dataset includes both the data contained in the original training dataset as well as any synthetic text phrases that are produced in accordance with steps 204-212. It is noted that steps 204-212 may be repeated a plurality of times for a plurality of different text phrases acquired from the original training dataset. Thus, the augmented training dataset may include a plurality of synthetic text phrases.

In step 214, the processing system may retrain the large language model using the augmented training dataset. As discussed above, steps 204-212 may be repeated multiple times prior to the retraining to generate a plurality of synthetic text phrases that are added to the original training dataset, so that the augmented training dataset that is used in the retraining includes a plurality of synthetic text phrases (as well as the text phrases contained in the original dataset, including text phrases that were not synthetically created). Retraining the LLM with the augmented training dataset exposes the LLM to a broader range of expressions and contexts that enhances the LLM’s ability to understand and respond to diverse real-world inputs effectively. The method 200 may end in step 216.

It should be noted that steps 204-212 may be repeated a plurality of times for a plurality of text phrases that are part of the original training dataset, and that the results of these repeated steps (e.g., a plurality of synthetic text phrases) may be added to the original training dataset to produce the augmented training dataset prior to the retraining of the LLM in step 214.

Thus, the method 200 boosts the volume of high-quality training data that is available to train an LLM, while also ensuring that the training data is diverse and contextually rich. The improved quality, diversity, and contextual richness of the training data will, in turn, lead to improved performance of the LLM. Moreover, automating the generation of the synthetic data used to augment the training dataset reduces the need for extensive manual data collection and annotation, which can be costly and challenging to scale across domains, as well as prone to human error. In other words, the method 200 provides a robust and efficient way to overcome the limitations of existing training datasets and enables more effective fine-tuning of LLMs, enhancing the applicability and performance of these LLMs in real-world scenarios.

It should be noted that the method 200 may be expanded to include additional steps or may be modified to include additional operations, parameters, or scores with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for generating synthetic data using generative artificial intelligence and taxonomy triplets may operate, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 405 for generating synthetic data using generative artificial intelligence and taxonomy triplets may operate (e.g., a software program comprising computer-executable instructions) can be loaded into memory 404 and executed by hardware processor element 402 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for generating synthetic data using generative artificial intelligence and taxonomy triplets may operate (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
acquiring, by a processing system including at least one processor, from a text phrase that is part of a training dataset used to train a large language model;
extracting, by the processing system from the text phrase, a subject-verb-object relationship;
rephrasing, by the processing system, the subject-verb-object relationship to produce a synthetic text phrase;
adding, by the processing system, the synthetic text phrase to the training dataset to produce an augmented training dataset; and
retraining, by the processing system, the large language model using the augmented training dataset.

2. The method of claim 1, wherein the training dataset comprises a plurality of text phrases.

3. The method of claim 2, wherein the plurality of text phrases is contained in a plurality of documents.

4. The method of claim 1, wherein the subject-verb-object relationship includes any words in the text phrase that occur after an object.

5. The method of claim 1, wherein the subject-verb-object relationship is extracted using a dynamic context optimization technique.

6. The method of claim 1, wherein the rephrasing comprises providing the subject-verb-object relationship as an input to a machine learning model that generates the synthetic text phrase as an output.

7. The method of claim 6, wherein the synthetic text phrase expresses the subject-verb-object relationship in a manner that is worded differently than the text phrase.

8. The method of claim 6, wherein the machine learning model is another large language model.

9. The method of claim 1, wherein the synthetic text phrase is validated prior to the adding to confirm that information contained in the synthetic text phrase does not contain an error.

10. The method of claim 1, wherein the synthetic text phrase is validated prior to the adding to confirm that the synthetic text phrase expresses information contained in the synthetic text phrase with a desired degree of clarity and conciseness.

11. The method of claim 1, wherein the synthetic text phrase is validated prior to the adding to confirm that the synthetic text phrase connects ideas expressed in the synthetic text phrase in a logical manner.

12. The method of claim 1, further comprising:
removing, by the processing system prior to the extracting, a word from the text phrase that is unrelated to a context of the text phrase.

13. The method of claim 12, wherein the word comprises an article.

14. The method of claim 1, wherein the augmented training dataset includes both observed text phrases extracted from documents and synthetic text phrases produced by the rephrasing.

15. The method of claim 1, wherein the retraining improves a diversity of real world inputs that the large language model is trained to understand and respond to.

16. A non-transitory computer-readable medium storing instructions which, when executed by a processing system including at least one processor, cause the processing system to perform operations, the operations comprising:
acquiring a text phrase that is part of a training dataset used to train a large language model;
extracting, from the text phrase, a subject-verb-object relationship;
rephrasing the subject-verb-object relationship to produce a synthetic text phrase;
adding the synthetic text phrase to the training dataset to produce an augmented training dataset; and
retraining the large language model using the augmented training dataset.

17. The non-transitory computer-readable medium of claim 16, wherein the rephrasing comprises providing the subject-verb-object relationship as an input to a machine learning model that generates the synthetic text phrase as an output.

18. The non-transitory computer-readable medium of claim 17, wherein the synthetic text phrase expresses the subject-verb-object relationship in a manner that is worded differently than the text phrase.

19. The non-transitory computer-readable medium of claim 16, wherein the augmented training dataset includes both observed text phrases extracted from documents and synthetic text phrases produced by the rephrasing.

20. A device comprising:
a processing system including at least one processor; and
a non-transitory computer-readable medium storing instructions which, when executed by the processing system, cause the processing system to perform operations, the operations comprising:
acquiring a text phrase that is part of a training dataset used to train a large language model;
extracting, from the text phrase, a subject-verb-object relationship;
rephrasing the subject-verb-object relationship to produce a synthetic text phrase;
adding the synthetic text phrase to the training dataset to produce an augmented training dataset; and
retraining the large language model using the augmented training dataset.
